(19) United States
(12) Patent Application Publication
(10) Pub. No.: US 2008/0270827 A1
(43) Pub. Date: Oct. 30, 2008

(54) RECOVERING DIAGNOSTIC DATA AFTER OUT-OF-BAND DATA CAPTURE FAILURE

(75) Inventors: Mark A. Brandyberry, Austin, TX (US); Shiva R. Dasari, Austin, TX (US); Jennifer L. Vargus, Cedar Park, TX (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/740,303

(22) Filed: Apr. 26, 2007

(51) Int. Cl. G06F 11/00

(52) U.S. Cl. 714/11

(57) ABSTRACT

Embodiments of the present invention address deficiencies of the art in respect to out-of-band management of system fault handling and provide a novel and non-obvious method, system and computer program product for recovering diagnostic data after out-of-band data capture failure. In an embodiment of the invention, a method for recovering diagnostic data after out-of-band data capture failure can include detecting an uncorrectable error in a coupled CPU. Thereafter, the coupled CPU can be placed in a quiesced state and the CPU can be warm reset. Error data can be retrieved from the CPU registers for the CPU and the CPU can be rebooted. Finally, the quiesced state of the CPU can be removed.

### BACKGROUND OF THE INVENTION

1. Field of the Invention

The present invention relates to the field of system fault handling and more particularly to out-of-band failure data capture during system fault handling.

2. Description of the Related Art

System fault handling refers to the process of detecting, diagnosing and recovering from system faults in a computing device. System faults can arise for many reasons including firmware errors, physical memory failures, communications lapses and the like. Generally, system fault handling includes the detection of the fault, the determination of whether or not a recovery is possible short of a system reset, the retrieval of diagnostic information including a dump of selected system registers and memory, and the implementation of a recovery process, including a hard or warm system restart.

System fault handling can be performed both in-band and out-of-band. The in-band management of system fault handling refers to the dedication of in-system resources configured to perform a portion of or the entirety of system fault handling. The in-band management of system fault handling enjoys the advantage of platform-level speed as the same resources that are monitored during fault handling support fault handling. Of course, it will be understood that the in-band management of system fault handling is as vulnerable to system failure as the monitored system itself. Accordingly, the modern enterprise computing platform favors the out-of-band management of system fault handling.

The out-of-band management of system fault handling differs from the in-band management of system fault handling in that an external set of computing resources support the operation of the out-of-band management of system fault handling for a different set of computing resources. In this regard, a dedicated management channel can be established between the monitored computing device and the resources supporting system fault handling so as to insulate the operation of system fault handling from the failure of the monitored computing device. At present, the Intelligent Platform Management Interface (IPMI) specification provides an industrial standard for the out-of-band management of system fault handling.

Many high-performance enterprise servers incorporate a baseboard management controller (BMC). A BMC generally refers to a microcontroller configured for the out-of-band management of system fault handling. Modern BMC implementations include a configuration for scanning out all error registers during system failure before resetting the system. Some BMC implementations only are able to scan out chipset registers as processor registers for some central processing unit (CPU) models are not accessible. Other BMC implementations are able to scan out both chipset registers and processor registers. In the latter circumstance, however, once a CPU enters a failing state, scanning out processor registers—especially through a joint test action group (JTAG) or other IEEE 1149.1 standard interface—is not viable.

### BRIEF SUMMARY OF THE INVENTION

Embodiments of the present invention address deficiencies of the art in respect to out-of-band management of system fault handling and provide a novel and non-obvious method, system and computer program product for recovering diagnostic data after out-of-band data capture failure. In an embodiment of the invention, a method for recovering diagnostic data after out-of-band data capture failure can include detecting an uncorrectable error in a coupled CPU. Thereafter, the coupled CPU can be placed in a quiesced state subsequent to warm resetting the CPU. Error data can be retrieved from the CPU registers for the CPU and the CPU can be rebooted to remove the quiesced state of the CPU.

In another embodiment of the invention, an out-of-band management data processing system can be configured for recovering diagnostic data after out-of-band data capture failure. The system can include a management control module coupled to a system board over a bus. The system board can include a CPU with corresponding CPU registers, and a supporting CPU chipset and corresponding chipset registers. The system also can include a BMC disposed in the management control module and coupled to the CPU over the bus. Finally, diagnostic data recovery logic can be coupled to the BMC. The logic can include program code enabled to respond to an uncorrectable error in the CPU by placing the CPU in a quiesced state subsequent to warm resetting the CPU, retrieving error data from the CPU registers, and rebooting the CPU to remove the quiesced state of the CPU.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an out-of-band management data processing system configured for recovering diagnostic data after out-of-band data capture failure; and,

FIG. 2 is a flow chart illustrating a process for recovering diagnostic data after out-of-band data capture failure.

### DETAILED DESCRIPTION OF THE INVENTION

Embodiments of the present invention provide a method, system and computer program product for recovering diagnostic data after out-of-band data capture failure. In accordance with an embodiment of the present invention, a system fault can be detected that requires a system reboot. Responsive to detecting the system fault, the system can be placed in a quiesced state (e.g. a suspended state). Once the system has entered the quiesced state, the error data can be retrieved out-of-band and a reboot can be applied to the system. Finally, the restart can complete and the quiesced state can be removed. In this way, the error data for the system fault can be retrieved out-of-band even though a reboot is required.

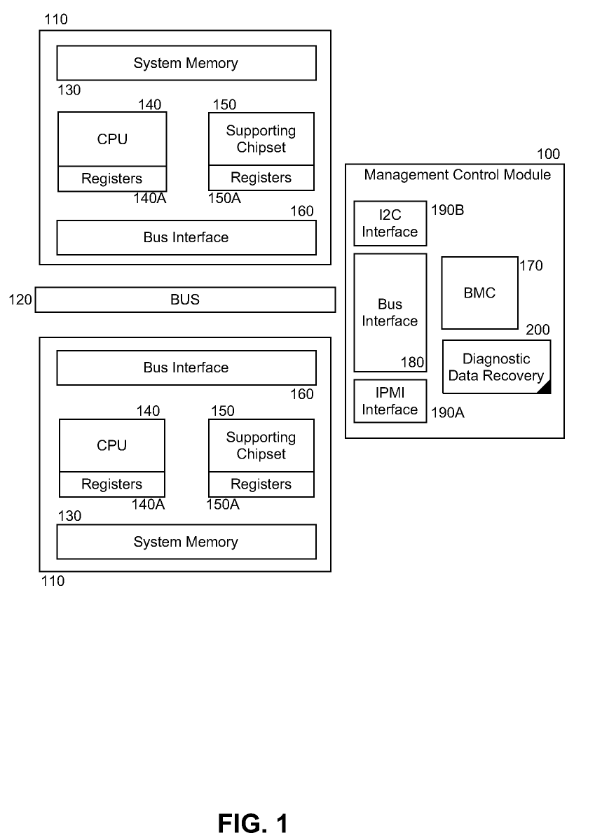

In further illustration, FIG. 1 is a schematic illustration of an out-of-band management data processing system configured for recovering diagnostic data after out-of-band data capture failure. The system can include one or more system boards 110 coupled to one another over a bus 120. Each of the system boards 110 can include a CPU 140 with corresponding processor registers 140A, and a supporting CPU chipset 150 with corresponding registers 150A. System memory 130 further can be provided such that each system board 110 can act as a self-sufficient computing device. Notably, a bus interface 160 can be provided over which power can be drawn from the bus 120 and through which external devices (including other system boards 110) can communicate.

A management control module 100 can be communicatively coupled to each system board 110 over the bus 120. The management control module 100 can include a BMC 170 providing out-of-band management of system fault handling in each of the system boards 110 through bus interface 180. In this regard, both an IPMI interface 190A and an inter-integrated circuit (I2C) interface can be provided through which out-of-band management of system fault handling for the system boards 110 can be achieved as is well-known in the art. Importantly, diagnostic data recovery logic 200 can be coupled to the BMC 170.

The diagnostic data recovery logic 200 can include program code enabled to recover error data from the processor registers 140A despite a failure of the out-of-band management of a system fault in the system board 110. Specifically, the program code can be enabled, upon detecting a system fault in the system board 100, to quiesce the CPU 140 subsequent to performing a warm reset on the CPU 140. The warm reset can unhang the CPU 140 so as to permit the program code of the diagnostic data recovery logic 200 to retrieve the error data in the CPU registers 140A as well as the chipset registers 150A.

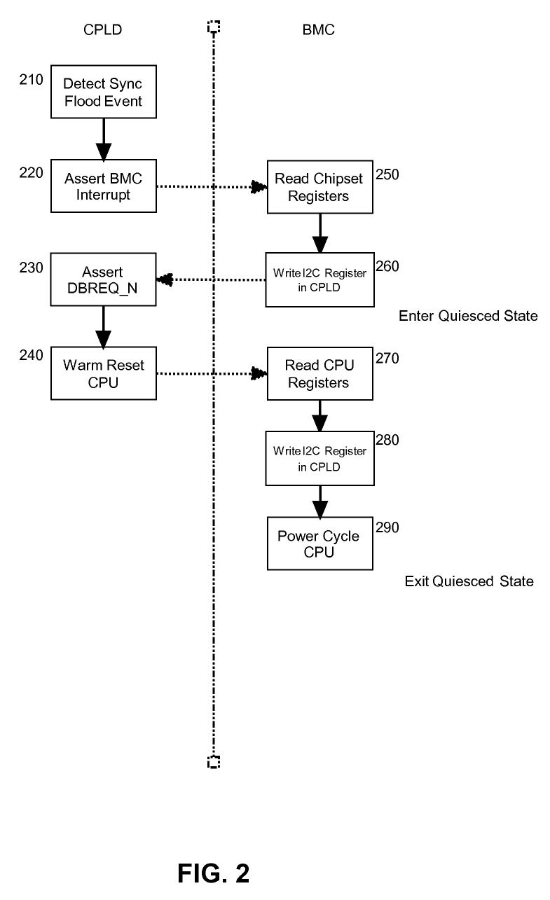

Once the error data has been retrieved out-of-band from the CPU registers 140A and the chipset registers 150A, the program code can be enabled to hard reset the CPU 140 so as to lift the quiesced state of the CPU 140. In this way, the error data can be retrieved from the CPU registers 140A despite the failure of the out-of-band management of the system fault recovery. In further illustration of the operation of the diagnostic data recovery logic 200, FIG. 2 is a flow chart illustrating a process for recovering diagnostic data after out-of-band data capture failure.

Beginning in 210, a complex programmable logic device (CPLD) coupled to the CPU via a JTAG interface can detect a sync flood event in the CPU indicating an uncorrectable error and a hung CPU. In block 220, an interrupt can be forwarded to the BMC alerting the BMC of the sync flood event. Thereafter, in block 230 the CPLD can assert DBREQ_N to the CPU and the CPU can be warm reset in block 240. Thereafter, in block 250, the chipset registers can be read out by the BMC and the CPU can be placed in a quiesced state by setting an appropriate register via I2C in block 260. In block 270, the CPU registers can be read by the BMC via JTAG. Once the error data has been retrieved from the now unhung CPU, in block 280 the I2C register can be set again and in block 290 the CPU can be power cycled. Thereafter, the quiesced state will have been removed.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for recovering diagnostic data after out-of-band data capture failure, the method comprising:
detecting an uncorrectable error in a coupled central processing unit (CPU);
placing the coupled CPU in a quiesced state subsequent to warm resetting the CPU;
retrieving data from CPU registers for the CPU; and,
rebooting the CPU to remove the quiesced state of the CPU.

2. The method of claim 1, wherein detecting an uncorrectable error in a coupled CPU comprises detecting a sync flood condition in the CPU.

3. The method of claim 1, wherein placing the coupled CPU in a quiesced state, comprises setting an inter-integrated circuit (I2C) interface register on a coupled complex programmable logic device (CPLD) and asserting DBREQ.

4. The method of claim 1, further comprising reading out error data from chipset registers for a chipset for the CPU.

5. The method of claim 3, wherein removing the quiesced state of the CPU, comprises resetting on the I2C interface register on a coupled complex programmable logic device (CPLD).

6. An out-of-band management data processing system configured for recovering diagnostic data after out-of-band data capture failure, the system comprising:
a management control module coupled to a system board over a bus, the system board comprising a central processing unit (CPU) with corresponding CPU registers, and a supporting CPU chipset and corresponding chipset registers;
a baseboard management controller (BMC) disposed in the management control module and coupled to the CPU over the bus; and,
diagnostic data recovery logic coupled to the BMC, the logic comprising program code enabled to respond to an uncorrectable error in the CPU by placing the CPU in a quiesced state, retrieving error data from the CPU registers, and rebooting the CPU to remove the quiesced state of the CPU.

7. The system of claim 6, further comprising an inter-integrated circuit (I2C) interface between the BMC and on a coupled complex programmable logic device (CPLD).

8. The system of claim 6, wherein the management control module supports the Intelligent Platform Management Interface (IPMI) specification.

9. A computer program product comprising a computer usable medium embodying computer usable program code for recovering diagnostic data after out-of-band data capture failure, the computer program product comprising:
computer usable program code for detecting an uncorrectable error in a coupled central processing unit (CPU);
computer usable program code for placing the coupled CPU in a quiesced state subsequent to warm resetting the CPU;
computer usable program code for retrieving data from CPU registers for the CPU; and,
computer usable program code for rebooting the CPU to remove the quiesced state of the CPU.

10. The computer program product of claim 9, wherein the computer usable program code for detecting an uncorrectable error in a coupled CPU comprises computer usable program code for detecting a sync flood condition in the CPU.

11. The computer program product of claim 9, wherein the computer usable program code for placing the coupled CPU in a quiesced state, comprises computer usable program code for setting an inter-integrated circuit (I2C) interface register on a coupled complex programmable logic device (CPLD) and asserting DBREQ.

12. The computer program product of claim 9, further comprising computer usable program code for reading out error data from chipset registers for a chipset for the CPU.

13. The computer program product of claim 11, wherein the computer usable program code for removing the quiesced state of the CPU, comprises resetting the I2C interface register on a coupled complex programmable logic device (CPLD).
